(19) United States
(12) Patent Application Publication
(10) Pub. No.: US 2025/0138966 A1
(43) Pub. Date: May 1, 2025

(54) TESTING A CLOUD INFRASTRUCTURE

(71) Applicant: Hewlett Packard Enterprise Development LP, Spring, TX (US)

(72) Inventors: Hiro Rameshlal Lalwani, Bangalore (IN); Rachit Gupta, Bangalore (IN); Sherine Jacob, Bangalore (IN); Kumar Gaurav, Bangalore (IN); Anand Andaneppa Ganjihal, Bangalore (IN)

(21) Appl. No.: 18/440,281

(22) Filed: Feb. 13, 2024

(30) Foreign Application Priority Data
Oct. 31, 2023 (IN) 202341074118

(51) Int. Cl. G06F 11/263

(52) U.S. Cl. CPC G06F 11/263

(57) ABSTRACT

In certain embodiments, a method includes receiving, at a framework controller executing, a test execution request comprising test parameters and an expected test outcome, wherein the test execution request comprises a request for testing a microservice architecture implemented in a cloud infrastructure; providing, by the framework controller, the test execution request and the test parameters to a framework injector executing on the one or more processors; providing, by the framework controller, the expected test outcome to a framework monitor executing on the one or more processors; executing, by the framework injector, a test corresponding to the test execution request using a test injector of a plurality of test injectors implemented by the framework injector; monitoring, by the framework monitor, a response of the microservice architecture of the cloud infrastructure to the test; and providing, by the framework controller and from the framework monitor, a test result based on the response.

### BACKGROUND

Information technology infrastructure and ecosystem deployments are growing increasingly complex. As the complexity increases, it may become challenging to comprehensively test such environments as a whole, and to determine the impact of various parts of the environment on other parts when failures occur.

### BRIEF DESCRIPTION OF THE DRAWINGS

Certain embodiments discussed herein will be described with reference to the accompanying drawings listed below. However, the accompanying drawings illustrate only certain aspects or implementations of embodiments described herein by way of example, and are not meant to limit the scope of the claims.

FIG. 1 illustrates a block diagram of an example system for implementing a testing framework for testing cloud infrastructure in accordance with one or more embodiments disclosed herein;

FIG. 2 illustrates a block diagram of an example framework injector 200 in accordance with one or more embodiments disclosed herein;

FIG. 3 illustrates an overview of an example method for testing a cloud infrastructure in accordance with one or more embodiments disclosed herein; and

FIG. 4 illustrates a block diagram of a computing device, in accordance with one or more embodiments of this disclosure.

### DETAILED DESCRIPTION

Entities providing technology and technology services are moving towards models that include microservices and other distributed technologies, which may be implemented in cloud infrastructure environments. As such models are adopted, the complexity of systems used to implement such technologies may increase. The complexity may increase the difficulty of predicting, identifying causes of, and/or recovering from system failures, which may result from failures in any number of places in the system, or a combination of such failures. Unexpected behaviors in a complex system, sudden outages of one or more hardware or software components, unexpected delays in response times, and other issues may, for example, lead to system outages during which an entity may be unable to provide a service to customers, leading to customer dissatisfaction.

As an example, an online application or service may be implemented using any number of microservices in a cloud computing infrastructure environment, where the hardware environment is distributed (e.g., in a public cloud, a private cloud, a hybrid cloud, etc.). Such microservices may be implemented, at least in part, using technologies such as container platforms (e.g., Kubernetes), virtualized instances of computing devices (e.g., virtual machines), etc. In such environments, it may be difficult to fully test the ability of the environment to handle or otherwise respond to various failures, errors, outages, etc., as such issues occurring in the environment may have an unpredictable effect on all or any portion of the remainder of the environment. Issues may include, but are not limited to, software crashes and/or errors (e.g., of container platforms, microservices, containers, pods, virtual machines, operating systems, backup and recovery software, databases, common services, communication protocols, applications, processes, etc.); crashes, panics, and/or other errors in hardware components (e.g., servers, other computing devices, network devices, storage devices, etc.); and/or errors and/or failures in communications between components. Various components or portions of distributed computing devices for implementing microservice-based architectures may be tested, but the system as a whole may not be fully tested and/or may not be tested in a production-like environment, which may lead to an unforeseen or otherwise unknown number of potential issues when the various components, pieces, portions, devices, etc. are assembled, connected, deployed, etc. and begin to execute to provide a service, application, etc. in a cloud infrastructure environment.

In order to address at least the aforementioned problems embodiments disclosed herein provide a comprehensive framework which may be used to robustly test microservice architectures implemented in cloud infrastructure environments. In one or more embodiments, the framework includes a framework controller, a framework injector, and a framework monitor, and the framework may be operatively connected to a cloud infrastructure environment in which a microservice architecture (e.g., for executing an application) is implemented.

In one or more embodiments, a framework controller is a component configured to receive input from a user (e.g., a test engineer). Such input may include a definition of what the user would like to test, and the expected outcome of performing the testing. In one or more embodiments, the framework controller provides details related to what the user desires to test to the framework injector, and provides the expected outcomes to the framework monitor.

In one or more embodiments, the framework injector may be configured to perform a variety of actions that may be implemented using several testing technologies, including, but not limited to, disruption technology, communication error technology, and crash point injection technology. The type of input required from the user, via the framework controller, may depend of the type of technology that the user desires to employ to perform testing of the microservice architecture and cloud infrastructure. The expected outcomes of the testing may depend to the types of testing specified by the user. Thus, a user interacting with the framework controller may be presented with the various categories of testing technologies, the different types of errors, crashes, panics, faults, etc., and that fall within each of the categories. In one or more embodiments, the user may select or otherwise specify the type of testing technology, the various actions the user desires to be performed using those technologies, and the expected outcome or response of performing those actions

One testing technology that the framework injector may be configured to implement is disruption technology. In one or more embodiments, disruption technology is a category of testing techniques that provides the capability for the user to cause introduction of crashes, panics, reboots, etc. of various components of the environment under test. In one or more embodiments, the crashes, panics, reboots, etc. may be caused on hardware devices (e.g., servers, network devices, etc.), platforms (e.g., Kubernetes platforms, container orchestration services, container management systems, virtual machine platforms, etc.), portions of systems hosting microservices, (e.g., containers, container pods, virtual machines), one or more microservices, authorization services, databases, workflow orchestration and management services, etc.

In one or more embodiments, a blast radius of the disruption may be controlled, depending on what portion of the microservice architecture and/or cloud infrastructure will have disruptions, such as crashes, panics, faults, etc. As an example, the disruption may be of a single container, a container pod, a container platform, a specific microservice of an application, microservices that are common to a variety of other portions of the system, and/or an entire container platform. In one or more embodiments, the disruptions specified by the user via the framework controller are provided to the framework injector.

In one or more embodiments, the framework injector is configured to perform actions to cause the desired disruptions. In one or more embodiments, the actions are performed using predefined commands, such as, for example, Kubernetes commands, various application programming interface (API) commands, etc., which will depend on the portion of the system that is to be disrupted. As an example: Kubernetes commands may be used to crash or cause panic of all or any portion of a container platform (e.g., cause a restart of a port); any components therein; any microservices implemented thereon, etc. As another example, various API commands may be used to induce crashes, panics, reboots, etc. of servers, network devices, storage devices, other hardware components, data backup orchestrators, etc.

In one or more embodiments, the framework monitor observes the environment into which the disruptions are introduced to determine whether the response of the environment to the disruption is as expected. As discussed above, in one or more embodiments, the expected outcome of particular tests is provided by the user via the framework controller. In one or more embodiments, the framework controller provides the expected outcomes to the framework monitor. In one or more embodiments, the framework monitor is configured to monitor the environment, and the components therein, to determine whether the actual response to the disruption matched the expectation provided by the user. As an example, the user may expect that a crash, panic, reboot, etc. of a hardware component would result in a failover to a redundant component, that the component recovers in a certain amount of time, that other portions of the environment continue to operate while the disrupted component recovers, etc. As another example, the user may specify the expected behavior of an application implemented using microservices when one or more of the microservices crashes. Other expected behaviors may be specified by the user without departing from the scope of embodiments disclosed herein. In one or more embodiments, if the result of the disruption does not match the expected outcome provided by the user, the framework monitor may provide an alert to the user. Such an alert may take any form, and may include any amount and/or type of information. As an example, the user may receive a notification indicating that the expected outcome did not occur, as well as various details on the response of the environment observed by the framework monitor.

Another testing technology that the framework injector may be configured to implement is communication error technology. In one or more embodiments, communication error technology includes inducing errors when communication operations are in progress. As an example, various communication protocols may include, but are not limited to, Representational State Transfer (REST) protocol, remote procedure call (RPC) frameworks (e.g., gRPC), Kafka protocol, etc., as well as other underlying protocols that may be used in communications, such as hypertext transfer protocol (HTTP), transmission control protocol (TCP), user datagram protocol (UDP), etc. Such protocols may be used for communicating data. Such protocols may have associated APIs that allow for various errors to be injected, such as, for example, delay injection, timeout errors, etc. Communication error technologies may also include causing other errors, such as resource errors (causing memory errors, causing processor errors, etc.), server busy errors (e.g., by inducing heavy loads on the compute resources of one or more servers), compliance errors (e.g., causing protocols to function in a way that is not compliant with expected behaviors), validation errors (e.g., causing errors in packet ordering). In one or more embodiments, any of the aforementioned communication errors may be specified by the user via the framework controller, and injected into the environment by the framework injector. In one or more embodiments, as discussed above, the framework monitor may monitor the environment to determine whether behavior observed in the environment matches the expected outcomes specified by the user, and, if not, an alert may be provided to the user.

Another testing technology that the framework injector may be configured to implement is crash point injection technology. In one or more embodiments, crash point injection technology includes strategically adding errors, faults, etc. in microservice code to cause failures at specific points. In one or more embodiments, injecting failure points into microservice code allows for the validation of the effectiveness of mechanisms in the microservice, such as undo operations, redo operations, retry operations, etc. As an example, certain operations may be performed by microservices in various stages, and crash points may be inserted into the microservice code that cause errors at specific points within those stages in order to validate that the microservice responds in an expected manner. As an example, a microservice may be configured to perform a restore operation from a previously created backup of data. The restore operation may have three stages, restoration of storage (e.g., from a snapshot), attaching the restored storage to a compute instance (e.g., an Amazon Elastic Cloud Compute (EC2) instance), and providing the updated information related to the storage attached to the instance to a manager service. In one or more embodiments, in such a scenario, a crash point may be injected into any point of any of the three stages to cause a failure. In one or more embodiments, a user, via the framework controller, specifies the stage at which the user desires the error to occur, as well as the expected outcome. Continuing the previous example, the user may provide an expected outcome that, if an error occurs in the third stage of a process being performed by a microservice, the microservice, after restart, will retry the third stage, but not redo the previous two stages, which were completed. Based on the input from the user, the framework controller may provide information to the framework injector, which may, in turn, add the appropriate one or more failure points to the code of the relevant microservice so that the microservice will reach the failure point during execution. In one or more embodiments, the framework monitor observes the behavior of the microservice, determines whether the behavior matches the expected outcome provided by the user, and alerts the user in the event that the observed behavior did not match the expected behavior.

Certain embodiments of this disclosure may provide a framework that allows for performing real-time testing on microservice architectures implemented in cloud infrastructures in order to uncover unexpected or otherwise improper responses of various components of the environment when faced with a variety of failure scenarios of different levels of complexity, which may improve the ability of such environments to be more robust and resilient, thereby helping to avoid system outages, downtime, etc.

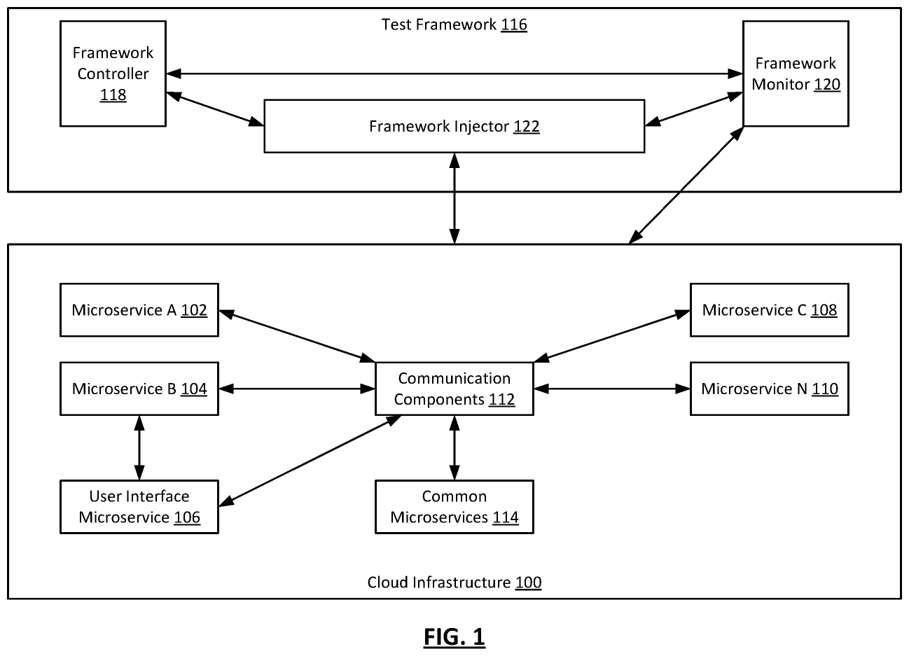

FIG. 1 illustrates a block diagram of an example system for implementing a testing framework for testing cloud infrastructure in accordance with one or more embodiments disclosed herein. As shown in FIG. 1, the system may include a cloud infrastructure 100. The cloud infrastructure 100 may include any number of microservices (e.g., microservice A 102, microservice B 104, microservice C 108, microservice N 110), a user interface microservice 106, one or more common microservices 114, and communication components 112. The system may also include a test framework 116. The test framework 116 may include a framework controller 118, a framework monitor 120, and a framework injector 122. Each of these components is described below.

In one or more embodiments, the cloud infrastructure 100 is a collection of any number of computing devices and other components in which a cloud computing environment is deployed, and which may host any number of applications, as-a-Service (aaS) products (e.g., Software aaS (SaaS), Infrastructure aaS (IaaS), Platform aaS (PaaS), Storage aaS (STaaS), etc.). In one or more embodiments, as used herein, a computing device may be any single computing device, a set of computing devices, a portion of one or more computing devices, or any other physical, virtual, and/or logical grouping of computing resources. In one or more embodiments, a computing device is any device, portion of a device, or any set of devices capable of electronically processing instructions and may include, but is not limited to, any of the following: one or more processors (e.g. components that include circuitry), memory (e.g., random access memory (RAM)), input and output device(s), non-volatile storage hardware (e.g., solid-state drives (SSDs), persistent memory (Pmem) devices, hard disk drives (HDDs) (not shown)), one or more physical interfaces (e.g., network ports, storage ports), any number of other hardware components (not shown), and/or any combination thereof.

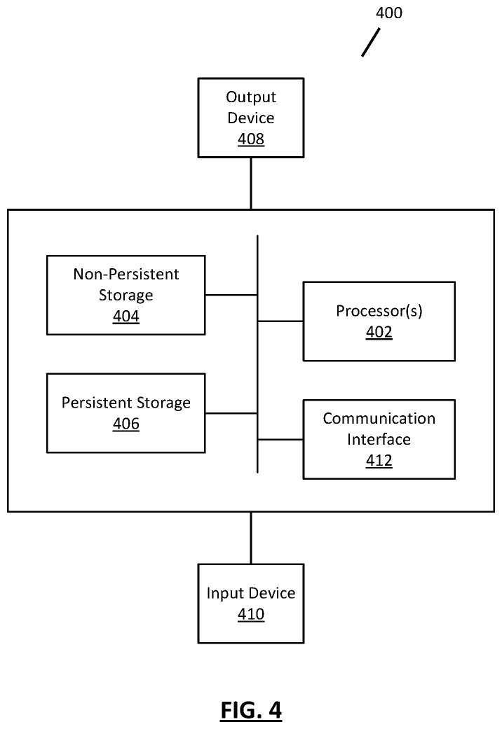

Examples of computing devices include, but are not limited to, a server (e.g., a blade-server in a blade-server chassis, a rack server in a rack, etc.), a desktop computer, a mobile device (e.g., laptop computer, smart phone, personal digital assistant, tablet computer, automobile computing system, and/or any other mobile computing device), a storage device (e.g., a disk drive array, a fibre channel storage device, an Internet Small Computer Systems Interface (ISCSI) storage device, a tape storage device, a flash storage array, a network attached storage device, etc.), a network device (e.g., switch, router, multi-layer switch, etc.), a virtual machine, a virtualized computing environment, a logical container (e.g., for one or more applications), an Internet of Things (IoT) device, an array of nodes of computing resources, a supercomputing device, a data center or any portion thereof, and/or any other type of computing device with the aforementioned requirements. In one or more embodiments, any or all the aforementioned examples may be combined to create a system of such devices, or may be partitioned into separate logical devices, which may collectively be referred to as a computing device. Other types of computing devices may be used without departing from the scope of embodiments described herein, such as, for example, the computing device shown in FIG. 4 and described below. The cloud infrastructure 100 may include any number and/or type of such computing devices in any arrangement and/or configuration without departing from the scope of embodiments disclosed herein.

In one or more embodiments, the storage and/or memory of a computing device or system of computing devices may be and/or include one or more data repositories for storing any number of data structures storing any amount of data (e.g., information). In one or more embodiments, a data repository is any type of storage unit and/or device (e.g., a file system, database, collection of tables, RAM, and/or any other storage mechanism or medium) for storing data. Further, the data repository may include multiple different storage units and/or devices. The multiple different storage units and/or devices may or may not be of the same type or located at the same physical location.

In one or more embodiments, any storage and/or memory of a computing device or system of computing devices may be considered, in whole or in part, as non-transitory computer readable mediums storing software and/or firmware.

Such software and/or firmware may include instructions which, when executed by the one or more processors (not shown) and/or other hardware (e.g., circuitry) of a computing device and/or system of computing devices, cause the one or more processors and/or other hardware components to perform operations in accordance with one or more embodiments described herein.

The software instructions may be in the form of computer readable program code to perform methods, processes, etc. of embodiments as described herein, and may, as an example, be stored, in whole or in part, temporarily or permanently, on a non-transitory computer readable medium such as a compact disc (CD), digital versatile disc (DVD), storage device, diskette, tape storage, flash storage, physical memory, or any other non-transitory computer readable medium.

The cloud infrastructure 100 may include any number of computing devices, any number of which may be collectively considered a computing device as used herein. All or any portion of the computing devices may be the same type or be different types of computing devices.

In one or more embodiments, all or any portion of the cloud infrastructure 100 may managed, at least in part, by a container platform (not shown), such as, for example, Kubernetes. In one or more embodiments, a container platform includes a control plane (not shown). A control plane of a container platform may include various components for managing the cloud infrastructure 100 (e.g., one or more API servers, controllers, schedulers, etc.). The control plane may, for example, be implemented on one or more master nodes, each of which may be a computing device (discussed above).

In one or more embodiments, the cloud infrastructure 100 includes the API server (not shown). In one or more embodiments, API server is a computing device of the cloud infrastructure 100, and executes in a control plane of a container platform. In one or more embodiments, the API server is configured to interact with entities (e.g., a testing framework 116, discussed below) seeking to configure and/or otherwise interact with various aspects of the container ecosystem. As an example, the API server may be configured to receive commands (e.g., to configure a container, to deploy a container instance, to terminate a container, to configure storage for a container, to configure networking for a container, to shut down a port, to restart pods, to disconnect carious components from other components, to induce crashes, to reboot components, etc.).

In one or more embodiments, the cloud infrastructure 100 may host any number of applications, which may be implemented using a microservice architecture that includes any number of microservices (e.g., microservice A 102, microservice B 104, microservice C 108, microservice N 110), as well as various other microservices (e.g., a user interface microservice 106, any number of common microservices 114) and various communication components that allow the various microservices to interact with other microservices, other parts of the cloud infrastructure 100, and/or entities and/or device outside the cloud infrastructure 100.

In one or more embodiments, a microservice (e.g., 102, 104, 106, 108, 110) may be implemented using any number of containers, container pods, etc. Each microservice (e.g., 102, 104, 106, 108, 110) may implement a particular service component that makes up part of an overall application deployed in the cloud infrastructure.

In one or more embodiments, the user interface microservice 106 may be a microservice that provides a user interface of any type (e.g., graphical, command line, etc.) for user of an application deployed as microservices of a microservice architecture.

In one or more embodiments, the common microservices 114 may be a set of services that are common to all or any portion of the other microservices (e.g., 102, 104, 106, 108, 110) of an application deployed using a microservice architecture in the cloud infrastructure 100. Examiners of common microservices include, but are not limited to, database services, authorization services, workflow orchestration microservices, auditing microservices, management microservices, etc.

In one or more embodiments, the cloud infrastructure 100 includes the communication components 112. In one or more embodiments, as used herein, communication components 112 include physical and/or logical devices and/or components that implement any number of communication protocols that allow microservice communication. As an example, various communication protocols may include, but are not limited to, Representational State Transfer (REST) protocol, remote procedure call (RPC) frameworks (e.g., gRPC), Kafka protocol, etc., as well as other underlying protocols that may be used in communications, such as hypertext transfer protocol (HTTP), transmission control protocol (TCP), user datagram protocol (UDP), etc. Such protocols may be used for communicating data, commands, etc.

Although FIG. 1 shows a particular set of microservices arranged in a particular manner, the cloud infrastructure 100 may include any microservice architecture with any number of microservices arranged and configured in any way without departing from the scope of embodiments disclosed herein. Such microservice architectures may be used to implement any type of application, any number of applications, and/or any other services (e.g., aaS products). Additionally all or any portion of any of the aforementioned devices, components, etc. (e.g., computing devices, servers, network devices, storage devices, container platforms, containers, container pods, microservices, virtual machines, etc.), in any combination, may be referred to herein as one or more components of a cloud infrastructure.

In one or more embodiments, the system shown in FIG. 1 includes a testing framework 116 operatively connected to the cloud infrastructure 100. In one or more embodiments, the testing framework 116 is implemented using any number of computing devices (described above). In one or more embodiments, the testing framework 116 includes a set of components that may be used to perform testing on a microservices architecture in the cloud infrastructure 100, monitor the results of the testing, and provide the results to relevant entities conducting the testing.

In one or more embodiments, the testing framework 116 includes a framework controller 118. The framework controller 118 may be any hardware, software, firmware, or any combination thereof that is configured to receive input from users related to testing components of the cloud infrastructure 100, and to provide information related to such input to other components of the testing framework 116. As an example, the framework controller 118 may be implemented using one or more computing devices (described above). In one or more embodiments, the framework controller 118 is a component configured to receive input from a user (e.g., a test engineer). Such input may include a definition of what the user would like to test, and the expected outcome of performing the testing. In one or more embodiments, the framework controller provides details related to what the user desires to test to the framework injector 122, and provides the expected outcomes to the framework monitor 120.

The type of input required from the user, via the framework controller 118, may depend of the type of testing technology that the user desires to employ to perform testing of the microservice architecture and cloud infrastructure. The expected outcomes of the testing may depend to the types of testing specified by the user. Thus, a user interacting with the framework controller 118 may be presented with the various categories of testing technologies, the different types of errors, crashes, panics, faults, etc., and that fall within each of the categories. In one or more embodiments, the user may select or otherwise specify the type of testing technology, the various actions the user desires to be performed using those testing technologies, and the expected outcome or response of performing those actions.

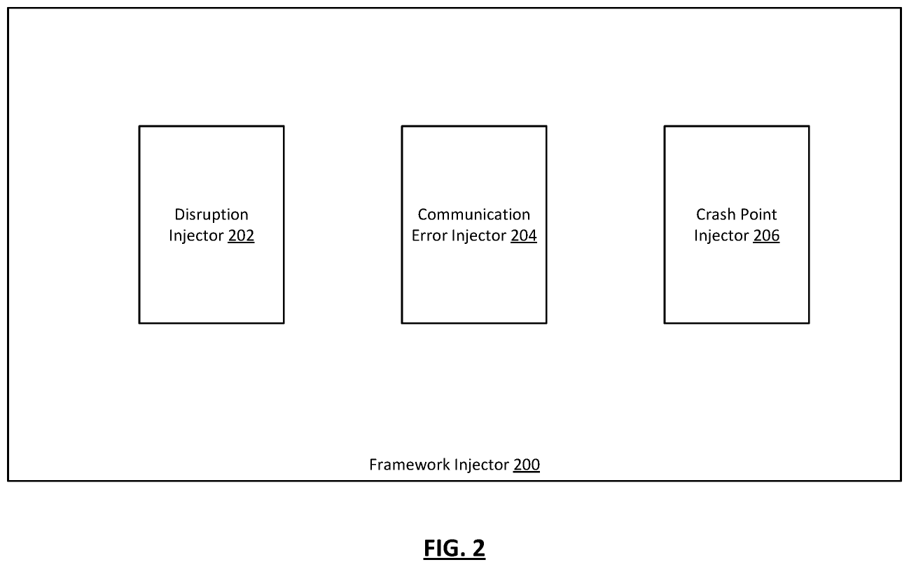

In one or more embodiments, the testing framework 116 includes the framework injector 122. The framework injector 122 may be any hardware, software, firmware, or any combination thereof that is configured to receive information based on user input from the framework controller 118, and use the information to perform any number of tests by interacting with various components of the cloud infrastructure 100. The framework injector 122 may include various components for performing such testing, including a disruption injector, a communication error injector, and a crash point injector (which may collectively be referred to as test injectors), each of which is described further in the description of FIG. 2, below.

In one or more embodiments, the testing framework 116 includes the framework monitor 120. The framework monitor may be any hardware, software, firmware, or any combination thereof that is configured to monitor the cloud infrastructure as tests are performed by the framework injector 122 to observe the results, effects, etc. of the testing on the various components of the cloud infrastructure 100, and to record the results and provide such results to the user initiating the testing.

In one or more embodiments, the framework monitor 120 observes the cloud infrastructure 100 into which the disruptions, errors, and/or crash points are introduced (e.g., injected by the framework injector 122) to determine whether the response of the cloud infrastructure 100 to the disruptions, errors, and/or crash points, are as expected. As discussed above, in one or more embodiments, the expected outcome of particular tests is provided by the user via the framework controller 118. In one or more embodiments, the framework controller 118 provides the expected outcomes to the framework monitor 120. In one or more embodiments, the framework monitor 120 is configured to monitor the cloud infrastructure 100, and the components therein, to determine whether the actual response to the disruptions, errors, and/or crash points matched the expected outcomes provided by the user.

As an example, the user may expect that a crash, panic, reboot, etc. of a hardware component would result in a failover to a redundant component, that the component recovers in a certain amount of time, that other portions of the environment continue to operate while the disrupted component recovers, etc. As another example, the user may specify the expected behavior of an application implemented using microservices when one or more of the microservices crashes. Other expected behaviors may be specified by the user without departing from the scope of embodiments disclosed herein. In one or more embodiments, if the result of the disruption, error, and/or crash point does not match the expected outcome provided by the user, the framework monitor may provide an alert to the user. Such an alert may take any form, and may include any amount and/or type of information. As an example, the user may receive a notification indicating that the expected outcome did not occur, as well as various details on the response of the cloud infrastructure 100 observed by the framework monitor 120.

In one or more embodiments, the framework controller 118, the framework monitor 120, and the framework injector 122 of the testing framework 116 may be implemented as part of a single computing device, or may be implemented as any number of separate and operatively connected computing devices.

While FIG. 1 shows a particular configuration of components, other configurations may be used without departing from the scope of embodiments described herein. For example, although FIG. 1 shows certain components as part of the same device, any of the components may be grouped in sets of one or more components which may exist and execute as part of any number of separate and operatively connected devices. As another example, a single component may be configured to perform all, or any portion of the functionality performed by the all or any portion of the components shown in FIG. 1. Accordingly, embodiments disclosed herein should not be limited to the configuration of components shown in FIG. 1.

FIG. 2 illustrates a block diagram of an example framework injector 200 in accordance with one or more embodiments disclosed herein. As shown in FIG. 2, the framework injector 200 includes a disruption injector 202, a communication error injector 204, and a crash point injector 206. Each of these components is described below.

In one or more embodiments, the framework injector 200 is the same or substantially similar to the framework injector shown in FIG. 1 and discussed above. As such, the framework injector 200 may be a component of a testing framework (e.g., the testing framework 116 shown in FIG. 1 and described above). The framework injector 200 may be operatively connected to a framework controller (e.g., the framework controller 118 shown in FIG. 1 and described above), a framework monitor (e.g., the framework monitor 120 shown in FIG. 1 and described above), and to a cloud infrastructure (e.g., the cloud infrastructure 100 shown in FIG. 1 and described above). The framework injector 200 may be any hardware, software, firmware, or any combination thereof configured to perform the functionality described herein. In one or more embodiments, the framework injector 200 is implemented using any number of computing devices (described above).

In one or more embodiments, the framework injector 200 includes the disruption injector 202. The disruption injector 202 may be any hardware, software, firmware, or any combination thereof configured to inject disruptions into any component, element, portion, etc. of a cloud infrastructure. In one or more embodiments, the disruption injector 202 is configured to implement testing techniques that provides the capability for the user to cause introduction of crashes, panics, reboots, etc. (e.g., disruptions) of various components of the environment under test (e.g., the cloud infrastructure 100 of FIG. 1). In one or more embodiments, the crashes, panics, reboots, etc. may be caused on hardware devices (e.g., servers, network devices, storage devices, etc.), platforms (e.g., Kubernetes platforms, container orchestration services, container management systems, virtual machine platforms, etc.), portions of systems hosting microservices, (e.g., containers, container pods, virtual machines, etc.), one or more microservices, authorization services, databases, workflow orchestration and management services, etc.

In one or more embodiments, a blast radius of the disruption may be controlled, depending on what portion of the microservice architecture and/or cloud infrastructure will have disruptions, such as crashes, panics, faults, etc. As an example, the disruption may be of a single container, a container pod, a container platform, a specific microservice of an application, microservices that are common to a variety of other portions of the system, and/or an entire container platform. In one or more embodiments, the disruptions specified by the user via a framework controller (e.g., the framework controller 118 of FIG. 1) are provided to the framework injector 200.

In one or more embodiments, the framework injector 200 is configured to perform actions to cause the desired disruptions (e.g., via the disruption injector 202) to components, devices, portions, etc. of a cloud infrastructure. In one or more embodiments, the actions are performed using predefined commands, such as, for example, Kubernetes commands, various application programming interface (API) commands, etc., which will depend on the portion of the cloud infrastructure that is to be disrupted. As an example: Kubernetes commands may be used to crash or cause panic of all or any portion of a container platform (e.g., cause a restart of a port); any components therein; any microservices implemented thereon, etc. As another example, various API commands may be used to induce crashes, panics, reboots, etc. of servers, network devices, storage devices, other hardware components, data backup orchestrators, etc.

In one or more embodiments, the framework injector 200 includes the communication error injector 204. In one or more embodiments, the communication error injector 204 is any hardware, software, firmware, or any combination thereof configured to induce errors in a cloud infrastructure when communication operations are in progress. As an example, various communication protocols may include, but are not limited to, the REST protocol, RPC frameworks (e.g., gRPC), the Kafka protocol, etc., as well as other underlying protocols that may be used in communications, such as HTTP, TCP, UDP, etc. Such protocols may be used, for example, for communicating data or any other information (e.g., commands). Such protocols may have associated APIs that allow for various errors to be injected, such as, for example, delay injection, timeout errors, etc. Communication error technologies may also include causing other errors, such as resource errors (causing memory errors, causing processor errors, etc.), server busy errors (e.g., by inducing heavy loads on the compute resources of one or more servers), compliance errors (e.g., causing protocols to function in a way that is not compliant with expected behaviors), validation errors (e.g., causing errors in packet ordering). In one or more embodiments, any of the aforementioned communication errors may be specified by a user via a framework controller (e.g., the framework controller 118 of FIG. 1), and injected into a cloud infrastructure by the framework injector 200. In one or more embodiments, as discussed above, a framework monitor (e.g., the framework monitor 120 of FIG. 1) may monitor the environment to determine whether behavior observed in the cloud infrastructure matches the expected outcomes specified by the user, and, if not, an alert may be provided to the user.

In one or more embodiments, the framework injector 200 includes the crash point injector 206. In one or more embodiments, the crash point injector 206 is any hardware, software, firmware, or any combination thereof configured to add crash points into code that may be executed in a cloud infrastructure environment. In one or more embodiments, crash point injection includes strategically adding errors, faults, etc. in microservice code, application code, etc. to intentionally cause failures at specific points. In one or more embodiments, injecting failure points into microservice or other code allows for the validation of the effectiveness of mechanisms in a microservice, such as undo operations, redo operations, retry operations, etc.

As an example, certain operations may be performed by microservices in various stages, and crash points may be inserted into the microservice code that cause errors at specific points within those stages in order to validate that the microservice responds in an expected manner. For example, a microservice may be configured to perform a restore operation from a previously created backup of data. The restore operation may have three stages, restoration of storage (e.g., from a snapshot), attaching the restored storage to a compute instance (e.g., an Amazon Elastic Cloud Compute (EC2) instance), and providing the updated information related to the storage attached to the instance to a manager service.

In one or more embodiments, in such a scenario, a crash point may be injected into any point of any of the three stages to cause a failure. In one or more embodiments, a user, via a framework controller (e.g., the framework controller 118 of FIG. 1), specifies the stage at which the user desires the error to occur, as well as the expected outcome. Continuing the previous example, the user may provide an expected outcome that, if an error occurs in the second stage of a process being performed by a microservice, the microservice, after restart, will retry the second stage if the error is injected after a certain point, but not redo the first stage, which was completed, and then continue to the third stage. Based on the input from the user, a framework controller (e.g., the framework controller 118 of FIG. 1) may provide information to the framework injector 200, which may, in turn, add the appropriate one or more failure points to the code of the relevant microservice so that the microservice will reach the failure point during execution. In one or more embodiments, a framework monitor (e.g., the framework monitor 120 of FIG. 1) observes the behavior of the microservice, determines whether the behavior matches the expected outcome provided by the user, and alerts the user in the event that the observed behavior did not match the expected behavior.

While FIG. 2 shows a particular configuration of components, other configurations may be used without departing from the scope of embodiments described herein. For example, although FIG. 2 shows certain components as part of the same device, any of the components may be grouped in sets of one or more components which may exist and execute as part of any number of separate and operatively connected devices. As another example, a single component may be configured to perform all, or any portion of the functionality performed by the all or any portion of the components shown in FIG. 2. Accordingly, embodiments disclosed herein should not be limited to the configuration of components shown in FIG. 2.

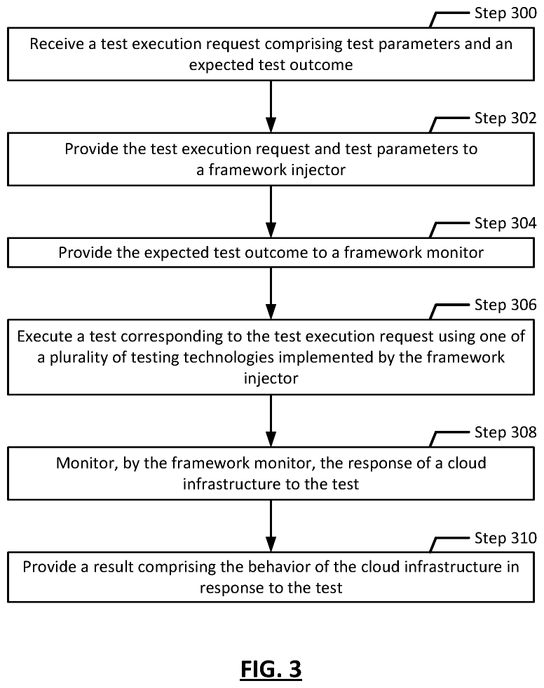

FIG. 3 illustrates an overview of an example method for testing a cloud infrastructure in accordance with one or more embodiments disclosed herein. The method may be performed, at least in part, by a testing framework (e.g., the testing framework 116 shown in FIG. 1), or any component of a testing framework (e.g., the framework controller 118 of FIG. 1, the framework monitor 120 of FIG. 1, the framework injector 122 of FIG. 1, the framework injector 200 of FIG. 2, the disruption injector 202 of FIG. 2, the communication error injector 204 of FIG. 2, the crash point injector of FIG. 2).

While the various steps in the flowchart shown in FIG. 3 are presented and described sequentially, some or all of the steps may be executed in different orders, some or all of the steps may be combined or omitted, and some or all of the steps may be executed in parallel with other steps of FIG. 3.

In Step 300, the method includes receiving a test execution request comprising test parameters and an expected test outcome. As an example, the test execution request may be received from a user by a framework controller (e.g., the framework controller 118 shown in FIG. 1) of a testing framework (e.g., the testing framework 116 of FIG. 1). In one or more embodiments, the test parameters are any information related to what one or more tests or test scenarios the user desires to be performed in a cloud infrastructure.

As an example, a user may want to test a microservice architecture implemented in a cloud infrastructure (e.g., the cloud infrastructure 100 of FIG. 1). The test parameters may depend on what one or more tests that are to be performed. In one or more embodiments, the framework controller includes a user interface that presents the user with options for different testing technologies that the testing framework is capable of performing. As an example, the framework controller may present to the user, or otherwise allow the user to enter, select, etc. one or more testing technologies (e.g., disruption injection, communication error injection, crash point injection, etc.). In one or more embodiments, the framework controller may further elicit or otherwise receive input from the user based on the type of testing that is to be performed.

As an example, if the user indicates that disruption injection testing is to be performed, the user may then provide as test parameters an identification of what components (e.g., servers, network devices, storage devices, certain sub-components, virtual machines, containers, container pods, microservices, applications, container platforms, etc.), as well as how such components are to be disrupted by the test (e.g., crashed, panicked, faulted, etc.) A test parameter may also include information related to the intended blast radius of the disruption (e.g., a single container, a single container pod, an entire microservice, an entire application, an entire container platform, a specified percentage or portion of devices of one or more types in the cloud infrastructure, etc.).

As another example, if the user indicates wanting to perform communication error injection testing, the framework controller may elicit or otherwise receive from the user information regarding one or more particular communication protocols (e.g., gRPC, Kafka, etc.) into which errors are to be injected, length of communication delays to be injected, devices and/or components on which errors are to be cause (e.g., memory errors, server busy errors due to overloading, etc.), compliance errors (e.g., causing behavior that does not conform with protocol specifications), validation errors (e.g., causing intention packet re-ordering on a particular one or more data paths), etc.

As another example, if the user indicates wanting to perform crash point injection testing, the framework controller may elicit or otherwise receive from the user details regarding what code, processes, stages, etc. of operations performed in a cloud infrastructure into which the user desires to have a crash or failure point injected. A user may generally specify (e.g., a crash point injected into stage two of a backup and restore process), or may specify with more particularity (e.g., a crash point to be injected into microservice code for a particular microservice when the conditions in a cloud environment meet certain specified parameters).

In one or more embodiments, an expected test outcome is what the user expects will happen when one or more tests are executed in the cloud infrastructure corresponding to the aforementioned test parameters. An expected test outcome may be any amount of information at any level of detail related to the response of all or any portion of a cloud infrastructure to any number of tests being performed by the testing framework. Examples include, but are not limited to, expecting a timely failover and resumption of service, a retry for at least a certain period of time before failing, expecting a service or application to continue operation after a failure of one or more microservices, containers, pods, etc.

In Step 302, the method includes providing the test execution request and test parameters to a framework injector. As an example, the test execution request and test parameters may be provided to the framework injector 122 of FIG. 1 or the framework injector 200 of FIG. 2 by the framework controller (e.g., the framework controller 118 of FIG. 1). The test execution request and test parameters may be provided to the framework injector using any technique for communicating information, such as passing an inter-process message, sending one or more packets over a network, etc. The test execution request and test parameters may match what was provided by the user to the framework controller, or may have been altered in any way by the framework controller to be in a form expected by the framework injector.

In Step 304, the method includes providing the expected test outcome to the framework monitor. As an example, a framework controller (e.g., the framework controller 118 of FIG. 1) may provide the expected test outcome to a framework monitor (e.g., the framework monitor 120 of FIG. 1). The expected test outcome may be provided to the framework injector using any technique for communicating information, such as passing an inter-process message, sending one or more packets over a network, etc. The expected test outcome may match what was provided by the user to the framework controller, or may have been altered in any way by the framework controller to be in a form expected by the framework injector.

In Step 306, the method includes executing a test corresponding to the test execution request using one of a plurality of testing technologies implemented by the framework injector and based at least in part on the test parameters. As an example, a framework injector (e.g., the framework injector 200 of FIG. 2) may determine, based on the test execution request, whether the test will use a disruption injector (e.g., the disruption injector 202 of FIG. 2), and a communication error injector (e.g., the communication error injector 204 of FIG. 2), a crash point injector (e.g., the crash point injector 206 of FIG. 2), or any combination thereof. In one or more embodiments, executing the test includes using the test parameters to configure the relevant one or more of the aforementioned injectors to initiate, perform, or otherwise conduct the tests requested by the test execution request. Executing the test may also include communicating information regarding the test to the framework monitor (e.g., what tests are being conducted, when the test is to start or has started, portions of a cloud infrastructure in which the testing is to occur, etc.).

In Step 308, the method includes monitoring the response of a cloud infrastructure to the test performed in Step 306. As an example, the cloud infrastructure may be monitored by a framework monitor (e.g., the framework monitor 120 of FIG. 1) while the test is being performed by the framework injector. In one or more embodiments, monitoring the cloud infrastructure include observing all or any portion of the cloud infrastructure using any appropriate technique for monitoring computing devices, software executing thereon, etc. As an example, the monitoring may include, but is not limited to: observing network traffic patterns, tracking states of components, devices, applications, containers, pods, virtual machines, etc.; monitoring results of operations (e.g., backup operations, restore operations, failover operations, retry operations, recovery operations, etc.). In one or more embodiments, the monitoring may include recording or otherwise generating or saving information related to the observed behavior of the cloud infrastructure during performance of the test.

In Step 310, the method includes providing a result comprising the behavior of the cloud infrastructure in response to the test. As an example, the result may be provided from the framework monitor to the framework controller to be presented to the user that requested the test. In one or more embodiments, the result includes whether or not the behavior observed in the cloud infrastructure during the test matched the expected test outcome provided by the user. The result may be in any suitable form for conveying information. For example, the result may be formatted into a report that details the outcome of the test, the behavior of various portions of the cloud infrastructure during the test, and whether the behavior matched the expected test outcome.

FIG. 4 illustrates a block diagram of a computing device, in accordance with one or more embodiments of this disclosure. As discussed above, embodiments described herein may be implemented using computing devices. For example, the all or any portion of the components shown in FIG. 1 may be implemented, at least in part, using one or more computing devices. The computing device 400 may include one or more computer processors 402, non-persistent storage 404 (e.g., volatile memory, such as random access memory (RAM), cache memory, etc.), persistent storage 406 (e.g., a hard disk, an optical drive such as a compact disk (CD) drive or digital versatile disk (DVD) drive, a flash memory, etc.), a communication interface 412 (e.g., Bluetooth interface, infrared interface, network interface, optical interface, etc.), input devices 410, output devices 408, and numerous other elements (not shown) and functionalities. Each of these components is described below.

In one or more embodiments, the computer processor(s) 402 may be an integrated circuit for processing instructions. For example, the computer processor(s) may be one or more cores or micro-cores of a processor. The processor 402 may be a general-purpose processor configured to execute program code included in software executing on the computing device 400. The processor 402 may be a special purpose processor where certain instructions are incorporated into the processor design. Although only one processor 402 is shown in FIG. 3, the computing device 400 may include any number of processors without departing from the scope of embodiments disclosed herein.

The computing device 400 may also include one or more input devices 410, such as a touchscreen, keyboard, mouse, microphone, touchpad, electronic pen, motion sensor, or any other type of input device. The input devices 410 may allow a user to interact with the computing device 400. In one or more embodiments, the computing device 400 may include one or more output devices 408, such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) 402, non-persistent storage 404, and persistent storage 406. Many different types of computing devices exist, and the aforementioned input and output device(s) may take other forms. In some instances, multimodal systems can allow a user to provide multiple types of input/output to communicate with the computing device 400.

Further, the communication interface 412 may facilitate connecting the computing device 400 to a network (not shown) (e.g., a local area network (LAN), a wide area network (WAN) such as the Internet, mobile network, or any other type of network) and/or to another device, such as another computing device. The communication interface 412 may perform or facilitate receipt and/or transmission of wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a BLE wireless signal transfer, an IBEACON® wireless signal transfer, an RFID wireless signal transfer, near-field communications (NFC) wireless signal transfer, dedicated short range communication (DSRC) wireless signal transfer, 802.11 WiFi wireless signal transfer, WLAN signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 412 may also include one or more Global Navigation Satellite System (GNSS) receivers or transceivers that are used to determine a location of the computing device 400 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

The term computer-readable medium includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

All or any portion of the components of the computing device 400 may be implemented in circuitry. For example, the components can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

In the above description, numerous details are set forth as examples of embodiments described herein. It will be understood by those skilled in the art (who also have the benefit of this disclosure) that one or more embodiments described herein may be practiced without these specific details, and that numerous variations or modifications may be possible without departing from the scope of the embodiments described herein. Certain details known to those of ordinary skill in the art may be omitted to avoid obscuring the description.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including functional blocks that may include devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but may have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

In the above description of the figures, any component described with regard to a figure, in various embodiments described herein, may be equivalent to one or more same or similarly named and/or numbered components described with regard to any other figure. For brevity, descriptions of these components may not be repeated with regard to each figure. Thus, each and every embodiment of the components of each figure is incorporated by reference and assumed to be optionally present within every other figure having one or more same or similarly named and/or numbered components. Additionally, in accordance with various embodiments described herein, any description of the components of a figure is to be interpreted as an optional embodiment, which may be implemented in addition to, in conjunction with, or in place of the embodiments described with regard to a corresponding one or more same or similarly named and/or numbered component in any other figure.

Throughout the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

While embodiments discussed herein have been described with respect to a limited number of embodiments, those skilled in the art, having the benefit of this disclosure, will appreciate that other embodiments can be devised which do not depart from the scope of embodiments as disclosed herein. Accordingly, the scope of embodiments described herein should be limited only by the attached claims.

What is claimed is:

1. A testing framework, comprising:
one or more processors;
a framework controller executing on the one or more processors;
a framework monitor executing on the one or more processors;
a framework injector executing on the one or more processors; and
one or more non-transitory computer readable media storing instructions which, when executed by the one or more processors, cause the one or more processors to:
receive, at the framework controller, a test execution request comprising test parameters and an expected test outcome, wherein the test execution request comprises a request for testing a microservice architecture implemented in a cloud infrastructure;
provide, by the framework controller, the test execution request and the test parameters to the framework injector;
provide, by the framework controller, the expected test outcome to the framework monitor;
execute, by the framework injector, a test corresponding to the test execution request using a test injector of a plurality of test injectors implemented by the framework injector;
monitor, by the framework monitor, a response of the microservice architecture of the cloud infrastructure to the test; and
provide, by the framework controller and from the framework monitor, a test result based on the response.

2. The testing framework of claim 1, wherein the test injector comprises a disruption injector.

3. The testing framework of claim 2, wherein the test is performed using the disruption injector and comprises inducing a disruption in one or more components of the cloud infrastructure.

4. The testing framework of claim 1, wherein the test injector comprises a communication error injector.

5. The testing framework of claim 4, wherein the test is performed using the communication error injector and comprises injecting a communication error into the cloud infrastructure.

6. The testing framework of claim 1, wherein the test injector comprises a crash point injector.

7. The testing framework of claim 6, wherein the test is performed using the crash point injector and comprises inserting a crash point into code corresponding to one or more components of the cloud infrastructure.

8. The testing framework of claim 1, wherein the test result comprises an indication of whether the response matches the expected test outcome.

9. A computer-implemented method, comprising:
receiving, at a framework controller executing on one or more processors, a test execution request comprising test parameters and an expected test outcome, wherein the test execution request comprises a request for testing a microservice architecture implemented in a cloud infrastructure;
providing, by the framework controller, the test execution request and the test parameters to a framework injector executing on the one or more processors;
providing, by the framework controller, the expected test outcome to a framework monitor executing on the one or more processors;
executing, by the framework injector, a test corresponding to the test execution request using a test injector of a plurality of test injectors implemented by the framework injector;
monitoring, by the framework monitor, a response of the microservice architecture of the cloud infrastructure to the test; and
providing, by the framework controller and from the framework monitor, a test result based on the response.

10. The computer-implemented method of claim 9, wherein the test injector comprises a disruption injector.

11. The computer-implemented method of claim 10, wherein the test is performed using the disruption injector and comprises inducing a disruption in one or more components of the cloud infrastructure.

12. The computer-implemented method of claim 9, wherein the test injector comprises a communication error injector.

13. The computer-implemented method of claim 12, wherein the test is performed using the communication error injector and comprises injecting a communication error into the cloud infrastructure.

14. The computer-implemented method of claim 9, wherein the test injector comprises a crash point injector.

15. The computer-implemented method of claim 14, wherein the test is performed using the crash point injector and comprises inserting a crash point into code corresponding to one or more components of the cloud infrastructure.

16. The computer-implemented method of claim 9, wherein the test result comprises an indication of whether the response matches the expected test outcome.

17. A non-transitory computer-readable medium storing programming for execution by one or more processors, the programming comprising instructions to:
receive, at a framework controller, a test execution request comprising test parameters and an expected test outcome, wherein the test execution request comprises a request for testing a microservice architecture implemented in a cloud infrastructure;
provide, by the framework controller, the test execution request and the test parameters to a framework injector;
provide, by the framework controller, the expected test outcome to a framework monitor;
execute, by the framework injector, a test corresponding to the test execution request using a test injector of a plurality of test injectors implemented by the framework injector;
monitor, by the framework monitor, a response of the microservice architecture of the cloud infrastructure to the test; and
provide, by the framework controller and from the framework monitor, a test result based on the response.

18. The non-transitory computer-readable medium of claim 17, wherein:
the test injector comprises a disruption injector, and
the test is performed using the disruption injector and comprises inducing a disruption in one or more components of the cloud infrastructure.

19. The non-transitory computer-readable medium of claim 17, wherein:
the test injector comprises a communication error injector, and
the test is performed using the communication error injector and comprises injecting a communication error into the cloud infrastructure.

20. The non-transitory computer-readable medium of claim 17, wherein:
the test injector comprises a crash point injector, and
the test is performed using the crash point injector and comprises inserting a crash point into code corresponding to one or more components of the cloud infrastructure.
